(19) United States
(12) Patent Application Publication
(10) Pub. No.: US 2018/0116202 A1
(43) Pub. Date: May 3, 2018

(54) Self Anchoring Rodent Bait Station

(71) Applicant: Andrew Burger, Miami Beach, FL (US)

(72) Inventor: Andrew Burger, Miami Beach, FL (US)

(21) Appl. No.: 15/335,713

(22) Filed: Oct. 27, 2016

(51) Int. Cl. A01M 25/00

(52) U.S. Cl. CPC A01M 25/004

(57) ABSTRACT

A bait station for exterminating rodents is secured by being weighted with water or some suitable weighting substance such as sand or fine gravel, and may use a liquid rodenticide that may be replenished without opening the bait station.

### BACKGROUND OF THE INVENTION

Rodents and rodent infestations have been a problem for humans extending as far back into human history as written records exist. Some species, in particular the brown rat, the black rat, and the house mouse are serious pests, eating and spoiling food stored by humans, and spreading diseases. The black plagues that wiped out significant numbers of people in Europe in the middle ages were a result of uncontrolled rodent populations in urban centers. Bubonic, septicemic, and pneumatic plagues were transmitted to humans through fleas carried by infected rodents. While plagues associated with infected rodents are largely a thing of the past in most developed countries, the incidence of rodent populations in areas inhabited by humans continues to be a problem that requires constant attention and activity to control.

Some rodent species are serious agricultural pests, eating large quantities of food stored by humans. For example, in 2003 the amount of rice lost to mice and rats in Asia was estimated to be enough to feed 200 million people. Most of the damage worldwide is caused by a relatively small number of species, chiefly rats and mice.

Because rodents are a nuisance and endanger public health, human societies expend significant efforts in an attempt to control them. Traditionally, this involved poisoning and trapping, methods that were not always safe or effective. Rodent bait traps are used for delivering lethal doses of rodenticides when it is necessary to rid residences, commercial establishments, or outdoor areas of rodents. The use of traps containing rodenticides, however, raises significant questions of safety. A common scenario is that domesticated pets, farm animals or wild game may dislodge and eat the toxic bait used in rodent traps, with the result that they will die and, in some cases, may pass the poison along to humans through meat or dairy products.

In order to mitigate the incidence of uncontrolled exposure to toxic rodenticides, various environmental and agricultural agencies in the United States and elsewhere have promulgated regulations to control the use of rodent bait traps. These regulations include the requirements that rodenticides must be used in stations that are resistant to destruction by dogs and by children under six years of age. They must be used in locations out of reach of children, pets, domestic animals and nontarget wildlife, or in tamper-resistant bait stations a manner that prevents such children from reaching into bait compartments and obtaining bait. If bait can be shaken from a bait station when lifted, the station must be secured or otherwise immobilized. Stronger bait stations must be used in areas open to hoofed livestock, raccoons, bears, or other potentially destructive animals, or in areas prone to vandalism. Bait stations are mandatory for outdoor, above-ground use, and tamper-resistant bait stations must be used wherever children, pets, non-target mammals, or birds may have access to the bait placement location.

The requirement that bait traps must be secured in a manner that will prevent them from being dislodged or inadvertently moved to a more accessible location has heretofore commonly been met by using stakes driven into the ground; or, where conditions do not allow the use of stakes, by weighting them down with heavy, dense substances such as rock, bricks, or concrete. However, given the variety and conditions of locations where rodent bait traps may be needed, and the difficulty of procuring or transporting heavy or dense weighting substances, there are times and conditions in which the use of a physically secured rodent bait trap is called for, but cannot easily be met. What is needed is a bait trap which may be easily transported and situated, and which may be weighted with a substance that is equally transportable or is easily available from locations in the field.

### SUMMARY OF THE INVENTION

The invention is a bait station which is secured by being weighted with water or some other suitable weighting substance such as sand or fine gravel. Once weighted, the bait station may be emplaced in a location suitable for discovery and use by rodents. A conventional bait station can be constructed to include one or more pockets or cavities into which water or another liquid may be introduced after the bait station has been situated. The liquid compartment is enclosed and sealed, weighting the bait station sufficiently to meet the requirement that the bait station be secured. Tightly closing and sealing the water compartment ensures that evaporation or other dissipation of the liquid can be avoided while the bait station is being used. When the station is to be removed or replaced, the liquid may be released and the lighter weight bait station can be more easily transported to another location for refilling or disposal.

In an alternative embodiment, the bait station may use a liquid rodenticide that may be replenished, when desired, through a filling tube in the bait station that can be accessed via a plug in the lid.

### BRIEF DESCRIPTION OF THE DRAWINGS

FIG. 1 is a perspective view of a bait station with an open lid, as seen from the front.

FIG. 2 is a perspective view of a bait station having a closed lid, as seen from the rear.

FIG. 3 is a front elevation view of the bait station.

FIG. 4 is a plan view of the bait station.

FIG. 5 is a rear elevation view of the bait station.

FIG. 6 is a perspective view of an alternative embodiment of the bait station.

FIG. 7 is a front elevation of an alternative embodiment of the bait station.

FIG. 8 is a plan view of an alternative embodiment of the bait station.

FIG. 9 is a rear elevation view of an alternative embodiment of the bait station.

### DETAILED DESCRIPTION OF THE PREFERRED EMBODIMENTS

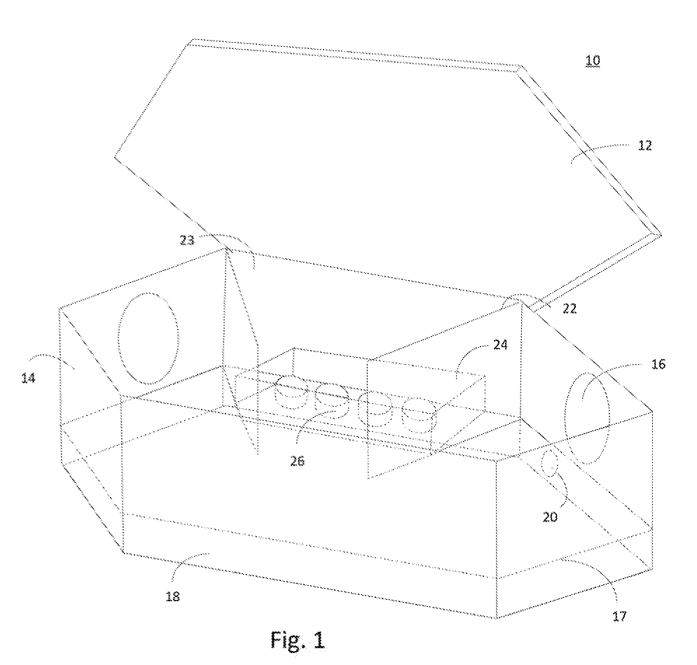

FIG. 1 depicts the bait station of this invention in a front perspective view. In FIG. 1, a bait station 10 has a closable lid 12. The lid may be secured when closed to prevent tampering or accidental opening and exposing of the rodenticide if the bait station should be dislodged from its installation. Secure closure can be achieved in a number of ways, including the use of screws, a location transition or location interference fit, or any other standard fitting that secures the lid in a closed position while still permitting a subsequent reopening. Closure mechanisms (not shown) are well known in the art, and any suitable closure method may be used to secure the lid. The bait station has two access openings 16 through which targeted rodents may enter or leave the interior space 14 within the upper portion of the bait station. An isolated weight compartment 18 is beneath and is separated from the interior space 14 by a floor 17. Weight compartment 18 can hold water, sand, or other weighting material that can be introduced through a small filler port 20. Within interior space 14, baffles 22 are used to direct the rodent into an inner chamber 23 in which rodenticide in the form of solid round pellets is retained within integral solid bait retainers 26 that secure the pellets within the inner chamber 23. The inner chamber 23 also forms an open rectangular box having walls 24 that will retain any rodenticide that may be scattered or spilled from the solid pellets while the bait station is being used. Placing the solid rodenticide within cylindrical retainers 26 and situating the retainers within the rectangular box 24 helps to keep rodenticide from falling out of the station if it should be moved, tipped, or accidentally overturned.

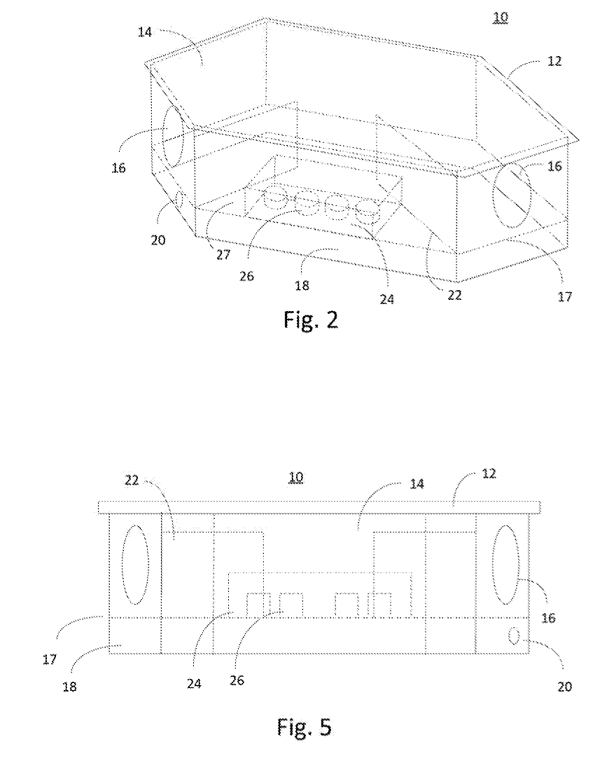

FIG. 2 shows the bait station 10 in a rear perspective view with the lid 12 closed, as will be the case when the bait station is being used. Access openings 16 allow entry and egress by rodents. A weighting material can be introduced into weight chamber 18 through filler port 20. An interior floor 17 separates weight chamber 18 from interior space 14. Interior space 14 allows rodents to enter the bait station and move around baffles 22 to access the inner chamber 23 containing the rodenticide.

As shown in FIGS. 1 and 2, water, sand, or some other fungible weighting material may be introduced into weight chamber 18 by an installer or station inspector who may find suitable weighting material at or near the place where the bait station is to be situated. By using weighting materials located at the site of the station, installation where stakes cannot be used may be accomplished without the need to pour a concrete bed, and does not require the installer to carry heavy, pre-weighted traps with him to the location where they are to be used. The invention allows a lightweight bait station to be transported to a place where it will be used, and then to be filled through port 20 to a weight sufficient to prevent it from being easily moved or dislodged. Once space 18 has been filled, the weighting substance can be retained within the bait station by plugging port 20 with a plug or other suitable stopper to prevent leakage depletion of the weighting material.

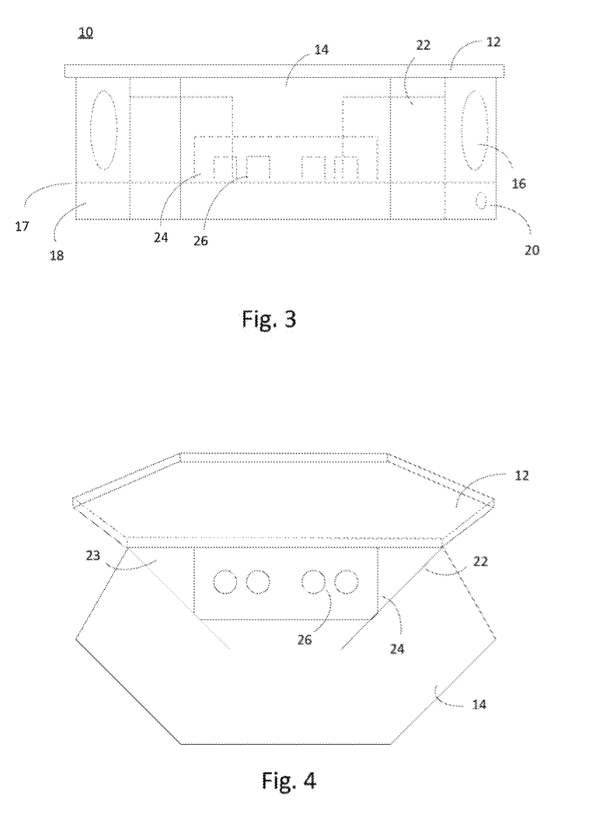

FIG. 3 is a front elevational view of the bait station of this invention. In this view it may be seen that the cavity for holding weight lies directly beneath floor 17 of the bait station and extends throughout the lower portion of the bait station. Four cylindrical solid bait retainers 26 for holding bait pellets are shown within open rectangular box 24.

FIG. 4 is a plan view of the bait station with the lid open to slightly more than 90° to allow an unimpeded view. Inner chamber 23 is formed by baffles 22 and defines a space where rodents may eat bait pellets held in solid bait retainers 26. By forming a semi-enclosure for inner chamber 23, baffles 22 may assist in giving target rodents a sense of security when they enter the trap to eat the rodenticide. An open rectangular box 24 surrounds the solid bait retainers, and serves to prevent flakes of rodenticide from being dislodged from the bait station if minor movement or shaking of the station should occur. Although FIG. 4 depicts the bait station roughly as a hexagonal shape, the shape of the bait station is not critical, and any number of other shapes could be used with equal effectiveness.

FIG. 5 is a rear elevational view of the bait station. Access holes 16 are located toward the rear of the bait station such that baffles 22 will prevent rodents within inner chamber 23 from having a clear view through the access holes to the outside. Filler port 20 is also located near the rear of the bait station, although the positioning of filler port 20 is not critical to the invention, and it may be situated anywhere on the perimeter of the bait station. Filler port 20 could even be situated in the bottom floor of the bait station if it is intended that the bait station be inverted during filling of the weight chamber.

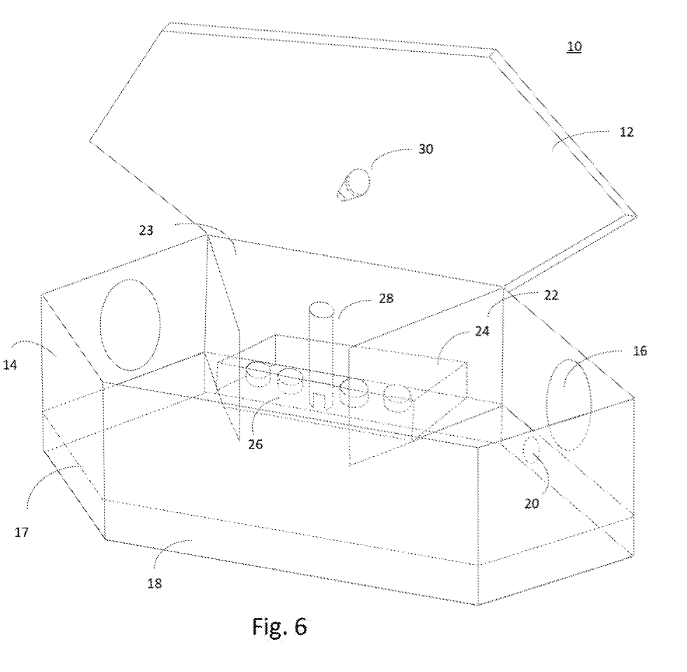

FIG. 6 is a perspective view of an alternative embodiment of the bait station. In this embodiment, a filler tube 28 is emplaced within a receptacle, shown as an open rectangular box 24, and extends vertically upward to a height that is near the lid 12 when the lid is securely closed. Lid 12 has an opening with a closable flap on the outside, and an attached funnel 30 that extends toward or into filler tube 28. Closable flap, funnel 30, and filler tube 28, allow liquid rodenticide to be introduced into bait station 10 through the lid and funnel 30, and into filler tube 28 where it runs down into open rectangular box 24. In this manner, a bait station may be refilled periodically with rodenticide without being moved or disturbed. Liquid rodenticide is pooled within rectangular box 24 where it may be consumed by rodents entering the bait station. Rectangular box 24 may be any shape, and it is not required that it be rectangular, but only that it form an enclosure open at the top for holding rodenticide where it may be eaten by target rodents.

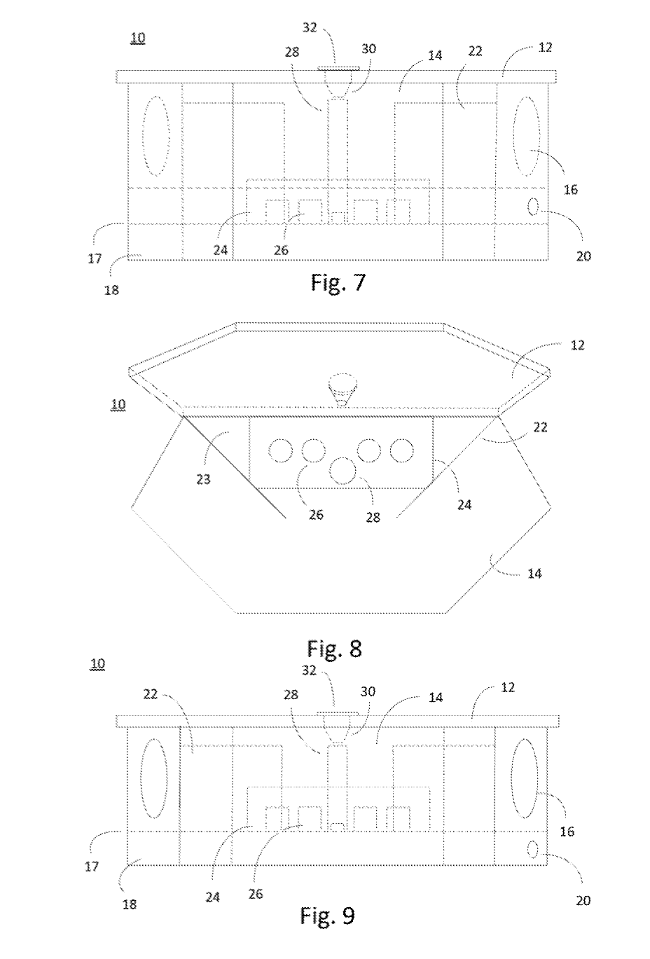

FIG. 7 is a front elevational view of the alternative embodiment of the invention. In FIG. 7, filler tube 28 extends vertically upward from rectangular box 24 to a point just below the opening and funnel 30 through lid 12. Closure flap 32 will normally be closed and secured with a snap-type mechanism, and will be opened only when liquid rodenticide is to be introduced into the bait station. FIGS. 8 and 9 provide a plan view and a rear elevational view, respectively, of the alternative embodiment of the invention.

The detailed descriptions given herein are not the exclusive configuration for practicing the invention, and persons of skill in the art will readily conceive of other configurations may be used for situating the weighting chamber or the liquid filler tube without departing from the scope and spirit of the invention, which is limited only by the following claims.

I claim:

1. A bait station for rodents comprising a housing through which rodents may gain ingress and egress;
said housing comprising an enclosure for retaining a rodenticide, said enclosure being open on at least one side sufficiently to permit a rodent to consume rodenticide from within said bait station;
said housing further comprising a weighting chamber having a volume sufficiently large to permit the introduction of weighting material into said weighting chamber, said weighting material being sufficiently heavy to hold said bait station in place against substantial movement caused by the normal use of said bait station.

2. A bait station as claimed in claim 1 wherein said weighting material is water.

3. A bait station as claimed in claim 1, wherein said enclosure comprises an opening sufficiently large to permit the entry of a rodent into said enclosure.

4. A bait station as claimed in claim 1 wherein said weighting chamber is situated below said enclosure.

5. A bait station as claimed in claim 4, said weighting chamber comprising a closable opening whereby said weighting material may be introduced into said weighting chamber through said closable opening immediately prior to said bait station being emplaced for use.

6. A bait station for rodents comprising a housing having a lid, said housing having one or more openings through which rodents may gain ingress and egress;
said housing comprising an enclosure having a receptacle for retaining a liquid rodenticide within said housing, said enclosure being open on at least one side sufficiently to permit a rodent to consume liquid rodenticide from within said enclosure;
a filler tube extending from said receptacle to an upper end from which said filler tube can receive liquid rodenticide from a source outside said bait station, said filler tube being hollow and being configured and situated to permit liquid rodenticide to flow by gravity through said filler tube from said upper end to said receptacle.

7. A bait station as claimed in claim 6, further comprising said lid having a closable opening therethrough and a frustoconical funnel having a large end and a small end, said large end of said funnel being attached to said lid immediately beneath said opening, said small end of said funnel extending toward the upper end of said filler tube whereby liquid rodenticide introduced into said bait station through said hole in said lid will flow into said upper end of said filler tube.

8. A bait station as claimed in claim 6, said bait station further comprising a weighting chamber for receiving weighting material.
